(19) United States
(12) Patent Application Publication
(10) Pub. No.: US 2005/0058778 A1
(43) Pub. Date: Mar. 17, 2005

(54) Bar coating method

(75) Inventors: Hisakazu Ijima, Tokyo (JP); Yutaka Shimizu, Tokyo (JP)

Correspondence Address: SEED INTELLECTUAL PROPERTY LAW GROUP PLLC, 701 FIFTH AVE, SUITE 6300, SEATTLE, WA, 98104-7092, US

(73) Assignee: TDK Corporation, Tokyo (JP)

(21) Appl. No.: 10/912,533

(22) Filed: Aug. 5, 2004

(30) Foreign Application Priority Data
Aug. 8, 2003 (JP) 2003-290288

(51) Int. Cl. B05D 3/12

(52) U.S. Cl. 427/356

(57) ABSTRACT

A bar coating method includes the steps of feeding a coating solution to a space defined by a rotatable bar, a supporting block adapted for supporting the bar, formed with a slit through which the coating solution is fed at an upstream portion of the bar and detachably mounted on a base plate vertically movable and held at a coating position thereof, and a pair of side plates disposed on the opposite sides of the supporting block with respect to a widthwise direction of a flexible support to be coated with a coating solution through the slit, thereby forming a liquid pool, transferring the coating solution forming the liquid pool onto a surface of the flexible support while guiding the flexible support by an upstream guide roller disposed upstream of the bar and a downstream guide roller disposed downstream of the bar, metering an amount of the coating solution transferred onto the flexible support, and forming a coating layer on the flexible support, and the bar coating method further includes the steps of gradually elevating the base plate from a retracted position thereof below the coating position thereof to the coating position thereof when starting a coating operation, while the bar is held stationary. According to this bar coating method, a coating layer having a desired thickness can be formed on the flexible support using a bar coating apparatus which can be made at low cost.

### BACKGROUND OF THE INVENTION

The present invention relates to a bar coating method and, particularly, to a bar coating method for using a bar coating apparatus which can be made at low cost to apply a coating solution onto the surface of a flexible support, so as to form a coating layer having a desired thickness thereon.

### DESCRIPTION OF THE PRIOR ART

There is known a bar coating method for forming a coating layer having a desired thickness on the surface of a flexible support by extruding a coating solution onto the surface of the flexible support on which a coating layer is to be formed, thereby forming a coating layer, pushing a rotating bar formed with a spiral groove on the surface thereof onto the coating layer, scraping an excessive coating solution off from the coating layer and metering an amount of the coating solution.

The bar coating method is widely used since a relatively good coating layer can be formed using an apparatus having a simple structure with simple operation.

Wide use has been made of a bar coating apparatus equipped with a coating solution transferring section for directly extruding a coating solution from a slit onto the surface of a flexible support, thereby transferring the coating solution thereonto, and with a separate coating solution metering section for scraping excessive coating solution transferred onto the surface of the flexible support using a bar to meter an amount of the coating solution. On the other hand, in order to make the bar coating apparatus compact, there has been proposed a bar coating apparatus in which a coating solution transferring section for directly extruding a coating solution from a slit onto the surface of a flexible support, thereby transferring the coating solution thereonto and a coating solution metering section for scraping excessive coating solution transferred onto the surface of the flexible support using a bar to meter an amount of the coating solution are integrated (For example, Japanese Patent Application Laid Open No. 6-296922 and the like).

However, in the case of directly extruding a coating solution from a slit onto the surface of a flexible support, thereby transferring the coating solution thereonto, it is indispensable to fabricate the slit with high accuracy in order to control the amount of coating solution transferred onto the surface of the flexible support in a desired manner and therefore, the cost of manufacturing the bar coating apparatus inevitably increases.

### SUMMARY OF THE INVENTION

It is therefore an object of the present invention to provide a bar coating method for using a bar coating apparatus which can be made at low cost to apply a coating solution onto the surface of a flexible support so as to form a coating layer having a desired thickness thereon.

The above and other objects of the present invention can be accomplished by a bar coating method comprising steps of feeding a coating solution to a space defined by a rotatable bar, a supporting block adapted for supporting the bar, formed with a slit through which the coating solution is fed at an upstream portion of the bar with respect to a transportation direction of a flexible support to be coated with a coating solution and detachably mounted on a base plate vertically movable and held at a coating position thereof, and a pair of side plates disposed on the opposite sides of the supporting block with respect to a widthwise direction of the flexible support through the slit formed in the supporting block, thereby forming a liquid pool, transferring the coating solution forming the liquid pool onto a surface of the flexible support while guiding the flexible support by an upstream guide roller disposed upstream of the bar with respect to the transportation direction of the flexible support and a downstream guide roller disposed downstream of the bar, metering an amount of the coating solution transferred onto the surface of the flexible support, and forming a coating layer on the surface of the flexible support, the bar coating method further comprising steps of gradually elevating the base plate from a retracted position thereof below the coating position thereof to the coating position thereof when starting a coating operation, while the bar is held stationary.

According to the present invention, since a coating solution is fed to a space defined by a rotatable bar, a support block adapted for supporting the bar and formed with a slit through which the coating solution is fed at an upstream portion of the bar with respect to a transportation direction of a flexible support to be coated with a coating solution and a pair of side plates disposed on the opposite sides of the support block with respect to a widthwise direction of the flexible support through the slit formed in the support block, thereby forming a liquid pool, and the coating solution forming the liquid pool is transferred onto the surface of the flexible support, it is possible to transfer a desired amount of the coating solution onto the surface of the flexible support without forming the slit with high accuracy.

Further, in a study done by the inventors of the present invention, it was experimentally confirmed that in the case where a coating operation was started by rotating the bar in a direction opposite to the transportation direction of the flexible support and gradually elevating the base plate from the retracted position thereof below the coating position thereof to the coating position thereof, streaks were formed on the coating layer and it was difficult to form a coating layer having a uniform thickness but that in the case where a coating operation was started by holding the bar stationary and gradually elevating the base plate from the retracted position thereof below the coating position thereof to the coating position thereof, no streaks were formed on the coating layer. Therefore, according to the present invention, after the base plate has been elevated to reach a predetermined position and the flexible support has come into contact with the coating solution forming the liquid pool, whereby the coating solution has been started to be transferred onto the surface of the flexible support, as the base plate is elevated, the amount of the coating solution transferred onto the surface of the flexible support is gradually increased but since the bar is held stationary, the coating solution transferred onto the surface of the flexible support is scraped off by the clearance between the surface of the bar and the surface of the flexible support. Therefore, it is possible to effectively prevent excessive coating solution from being transferred onto the surface of the flexible support when the coating operation is started.

In a preferred aspect of the present invention, the downstream guide roller is constituted so as to be movable between a coating position thereof and a retracted position thereof above the coating position and when a coating operation is started, the downstream guide roller is lowered from the retracted position thereof to the coating position thereof to be held at the coating position thereof.

In a preferred aspect of the present invention, the pair of side plates are disposed inside of opposite edge portions of the flexible support to be coated with the coating solution.

According to this preferred aspect of the present invention, since the pair of side plates are disposed inside of opposite edge portions of the flexible support to be coated with the coating solution, the width of the liquid pool formed by the coating solution can be restricted by the pair of side plates and regions coated with no coating solution can be left at the opposite edge portions of the flexible support. Therefore, when the flexible support formed with the coating layer is reeled off, it is possible to reliably prevent the coating layers formed at the opposite edge portions of the flexible support from adhering to themselves and the flexible support from being torn when the flexible support is unwound.

In a preferred aspect of the present invention, a top portion of the support block has a substantially triangular shaped cross section at an upstream portion of the bar.

According to this preferred aspect of the present invention, since a top portion of the support block has a substantially triangular shaped cross section at an upstream portion of the bar, it is possible to form a liquid pool including a sufficient amount of the coating solution between the bar, the support block and the pair of side plates and, therefore, a desired amount of the coating solution can be transferred onto the surface of the flexible support without forming a slit with high accuracy.

In a further preferred aspect of the present invention, the support block includes a first support block for supporting the bar and a second support block whose top portion has a substantially triangular shaped cross section, the slit is formed between the first support block and the second support block, and the bar, the first support block, the second support block and the pair of side plates are disposed so that a coating solution fed through the slit formed in the support block forms the liquid pool in a space defined by the bar, the top portion of the second support block and the pair of side plates.

According to this preferred aspect of the present invention, since the support block includes a first support block for supporting the bar and a second support block having the top portion having a substantially triangular shaped cross section, the slit is formed between the first support block and the second support block, and the bar, the first support block, the second support block and the pair of side plates are disposed so that a coating solution fed through the slit formed in the support block forms the liquid pool in a space defined by the bar, the top portion of the second support block and the pair of side plates, it is possible to form a liquid pool including a sufficient amount of the coating solution between the bar, the support block and the pair of side plates and, therefore, a desired amount of the coating solution can be transferred onto the surface of the flexible support without forming a slit with high accuracy.

In a further preferred aspect of the present invention, the first support block is made of a metal softer than that of the bar.

According to this preferred aspect of the present invention, since the first support block is made of a metal softer than that of the bar, it is possible to effectively prevent the bar from being galled due to the contact with the first support block and the thickness of the coating layer from varying with the lapse of time.

The above and other objects and features of the present invention will become apparent from the following description made with reference to the accompanying drawings.

### BRIEF DESCRIPTION OF THE DRAWINGS

FIG. 1 is a schematic cross-sectional view showing a bar coating apparatus which is a preferred embodiment of the present invention.

FIG. 2 is a schematic center cross-sectional view taken along a line A-A in FIG. 1.

FIG. 3 is a schematic partial side view of a bar coating apparatus shown in FIG. 1.

FIG. 4 is a schematic front view showing a bar pressing device.

FIG. 5 is a schematic cross-sectional view showing a bar coating apparatus when a coating solution is started to be fed to a slit and a liquid pool is just formed.

### DESCRIPTION OF THE PREFERRED EMBODIMENTS

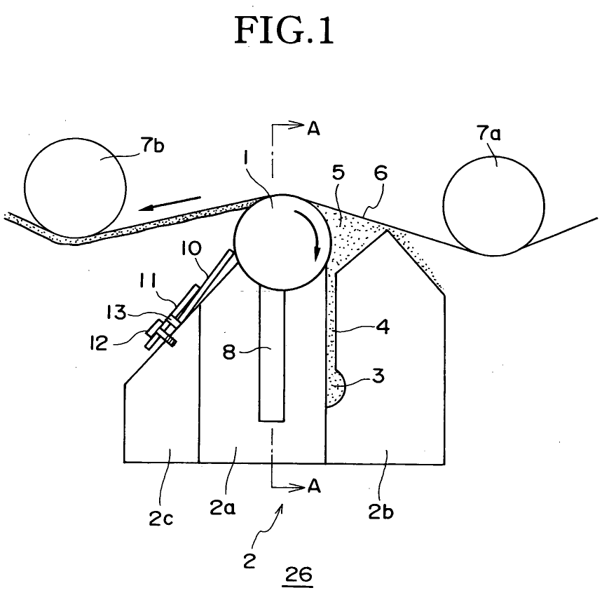

FIG. 1 is a schematic cross-sectional view showing a bar coating apparatus which is a preferred embodiment of the present invention.

As shown in FIG. 1, a bar coating apparatus according to this embodiment includes a bar 1 formed with a spiral groove (not shown) on the surface thereof and a support block 2 for supporting the bar 1.

The bar 1 has a diameter of about 10 mm, for example.

As shown in FIG. 1, in this embodiment, the support block 2 includes a first support block 2a, a second support block 2b and a third support block 2c integrally formed with each other and a slit 4 is formed between the first support block 2a and the second support block 2b and adapted for feeding a coating solution via a pocket 3.

In this embodiment, the bar 1 is made of a stainless steel which can be processed with high accuracy and the first support block 2a against which the bar abuts is made of a softer material such as brass, copper or the like than stainless steel in order to prevent the bar 1 from galling. On the other hand, the second support block 2b and the third support block 2c against which the bar 1 does not abut are made of a stainless steel.

As shown in FIG. 1, the top portion of the second support block 2b has a substantially triangular cross section and a liquid pool 5 of a coating solution fed through the slit 4 is formed between the top portion of the second support block 2b and the bar 1.

The bar 1 is rotated in the opposite direction to the transportation direction of a flexible support 6, namely, clockwise in FIG. 1, and the flexible support 6 formed of polyethylene terephthalate or the like is transported while being strongly pressed by an upstream guide roller 7a and a downstream guide roller 7b onto the surface of the bar 1.

In this embodiment, the upstream guide roller 7a and the downstream guide roller 7b are respectively movable by an upstream guide roller moving means (not shown) and a downstream guide roller moving means (not shown) between their coating positions shown in FIG. 1, namely, positions where a coating solution can be transferred onto the surface of the flexible support 6 and their retracted positions above their coating positions.

As shown in FIG. 1, the first support block 2a is formed with a drain passage 8 for discharging excessive coating solution below the bar 1. The lower end portion of the drain passage 8 extends widthwise and is inclined downwardly so that a coating solution flowing into the drain passage 8 can be easily collected.

As shown in FIG. 1, a doctor blade 10 is mounted on the third support block 2c for scraping a coating solution adhered to the surface of the bar 1 and a coating solution accompanying the surface of the bar 1.

The width of the doctor blade 10 is larger than that of the liquid pool 5 and in this embodiment, the doctor blade 10 is formed of polyester resin.

As shown in FIG. 1, in this embodiment, a blade pressing plate 11 is secured by a screw 12 to the third support block 2c. The doctor blade 10 is inserted into a space between the first support block 2a and the third support block 2c, and the blade pressing plate 11 until it comes into abutment with a positioning pin 13 penetrating the blade pressing plate 11 and when the doctor blade 10 comes into abutment with the positioning pin 13, the screw 12 is fastened, whereby the doctor blade 10 is fixed onto the first support block 2a and the third support block 2c.

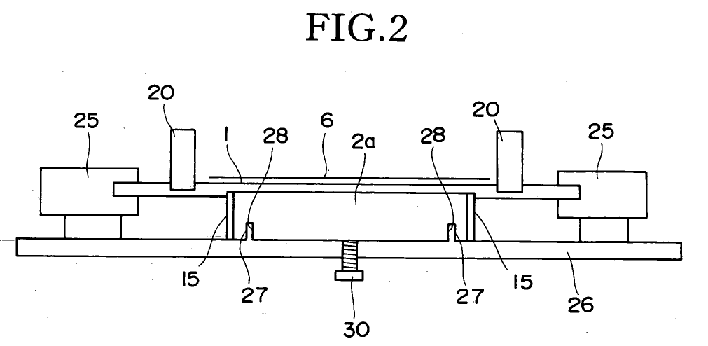

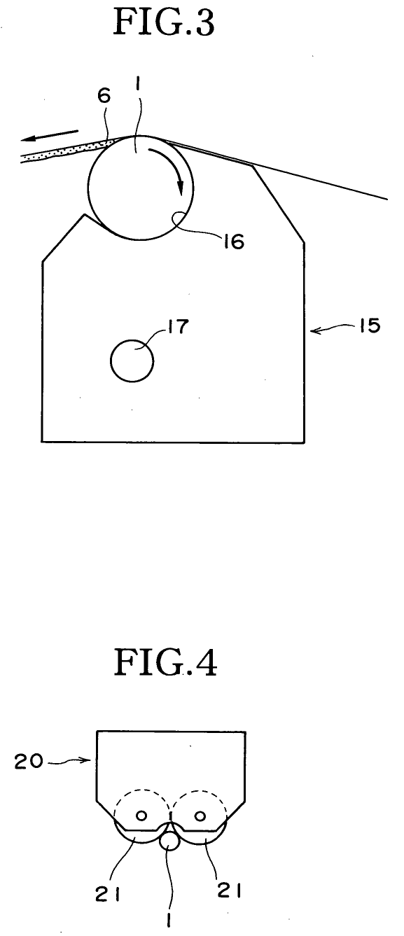

FIG. 2 is a schematic center cross-sectional view taken along a line A-A in FIG. 1 and FIG. 3 is a schematic partial side view of a bar coating apparatus shown in FIG. 1.

As shown in FIGS. 2 and 3, a pair of side plates 15, 15 is disposed inside of opposite edge portions of the flexible support 6 for defining opposite end portions of the liquid pool 5 and the bar 1 extends to opposite sides of the pair of side plates 15, 15 through cut portions 16 formed in the pair of side plates 15, 15.

In the case where the upper portions of the side plates 15, 15 come into contact with the flexible support 6, since there is a risk of static electrical charge being generated, the pair of side plates 15, 15 is disposed so as to form a small gap between the upper portions thereof and the flexible support 6, for example, 0.1 mm.

In this embodiment, the side plates 15, 15 are made of polytetrafluoroethylene.

As shown in FIG. 3, the cut portions 16 are shaped so that the bar 1 can be easily attached to or removed from the bar coating apparatus via the cut portions 16.

As shown in FIG. 3, each of the pair of side plates 15, 15 is formed with an opening 17 and the drain passage 8 extends through the openings 17.

As shown in FIG. 2, bar pressing devices 20 are disposed so as to be able to abut against portions of the bar 1 outside of the pair of side plates 15, 15.

FIG. 4 is a schematic front view showing the bar pressing device 20.

As shown in FIG. 4, each of the bar pressing devices 20 includes two rubber rollers 21, 21 each of which can be moved vertically by a driving mechanism (not shown) and driven and the portions of the bar 1 outside of the pair of side plates 15, 15 are pressed by the two rubber rollers 21, 21, whereby the bar 1 is prevented from being bent when it is rotated.

As shown in FIGS. 1 and 2, the first support block 2a, the second support block 2b and the third support block 2c are mounted onto a base plate 26 to which a bar driving mechanism 25 are fixed.

As shown in FIG. 2, the upper surface of the base plate 26 is formed with two positioning pins 27, 27 and on the other hand, the lower surface of the first support block 2a is formed with two positioning holes 28, 28.

Therefore, when the support block 2 is fixed to the base plate 26, the support block 2 is positioned on the base plate 26 so that the two positioning pins 27, 27 of the base plate 26 are inserted into the two positioning holes 28, 28 of the first support block 2a and the support block 2 is fixed to the base plate 26 by a setscrew (not shown).

As shown in FIG. 2, an adjusting screw 30 is provided at the central portion of the base plate 26 so that the central portion of the lower surface of the first support block 2a fixed to the base plate 26 can be pushed upward by the adjusting screw 30.

Further, the base plate 26 is constituted so as to be movable by a base plate moving mechanism (not shown) between a coating position thereof shown in FIG. 1, namely, a position where coating solution can be transferred onto the surface of the flexible support 6, and a retracted position thereof below the coating position thereof.

In the case where the surface of the flexible support 6 is coated with a coating solution using the thus constituted bar coating apparatus, the first support block 2a is first mounted on the base plate 26 on which the bar driving mechanism 25 is fixed.

At this time, the base plate 26 is held at the retracted position thereof below the coating position thereof shown in FIG. 1 and the downstream guide roller 7b is held at the retracted position thereof above the coating position thereof.

When the support block 2 is fixed to the base plate 26, the support block 2 is positioned on the base plate 26 so that the two positioning pins 27, 27 formed on the upper surface of the base plate 26 are inserted into the two positioning holes 28, 28 of the first support block 2a and the support block 2 is fixed to the base plate 26 by a setscrew (not shown).

In this manner, since the support block 2 is positioned on the base plate 26 so that the two positioning pins 27, 27 formed on the upper surface of the base plate 26 are inserted into the two positioning holes 28, 28 of the first support block 2a and the support block 2 is fixed to the base plate 26, the support block 2 can be positioned at a desired position on the base plate 26 and fixed to the base plate 26.

Then, the bar 1 is set in the bar driving mechanism 25 so as to be located on the first support block 2a.

Further, the doctor blade 10 is inserted into a space between the first support block 2a and the third support block 2c, and the blade pressing plate 11 until it comes into abutment with the positioning pin 13 penetrating the blade pressing plate 11 and when the doctor blade 10 comes into abutment with the positioning pin 13, the screw 12 is fastened, whereby the doctor blade 10 is fixed onto the first support block 2a and the third support block 2c.

Then, each of the bar pressing devices 20 is lowered and portions of the bar 1 outside of the pair of side plates 15, 15 are pressed by the pair of rubber rollers 21, 21 of each of the bar pressing devices 20.

At this time, the bar driving mechanism 25 has not yet been driven and the bar 1 is held stationary.

Thereafter, the flexible support 6 is started to be transported by a transporting means (not shown) and the downstream guide roller 7b positioned at the retracted position thereof is moved to the coating position thereof by the downstream guide roller moving means (not shown) and held at the coating position thereof. To the contrary, the base plate 26 is held at the retracted position thereof below the coating position thereof.

Then, a coating solution is fed by a pump (not shown) to the slit 4 via the pocket 3 to form a liquid pool 5.

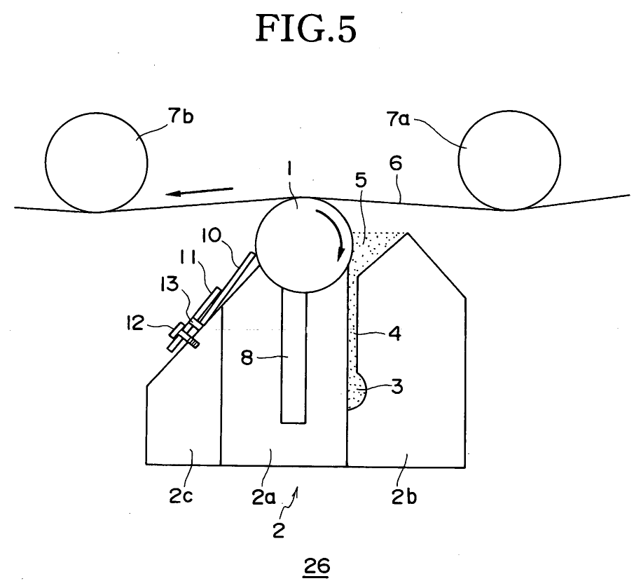

FIG. 5 is a schematic cross-sectional view showing the bar coating apparatus when the coating solution is started to be fed to the slit 4 and the liquid pool 5 is just formed.

As shown in FIG. 5, at this time, since the base plate 26 is held at the retracted position thereof below the coating position thereof and the flexible support 6 is not in contact with a coating solution forming the liquid pool 5, the coating solution is not transferred onto the flexible support 6.

Then, the base plate moving means (not shown) is driven and the base plate 26 is gradually elevated toward the coating position thereof.

When the base plate 26 is elevated to reach a predetermined position, the flexible support 6 comes into contact with the coating solution forming the liquid pool 5.

As a result, coating solution is started to be transferred onto the surface of the flexible support 6 and as the base plate 26 is elevated, the amount of coating solution transferred onto the surface of the flexible support 6 gradually increases.

In a study done by the inventors of the present invention, it was experimentally confirmed that in the case where a coating operation was started by rotating the bar 1 in a direction opposite to the transportation direction of the flexible support 6 and gradually elevating the base plate 26 from the retracted position thereof below the coating position thereof to the coating position thereof, streaks were formed on the coating layer and it was difficult to form a coating layer having a uniform thickness but to the contrary, that in the case where a coating operation was started by holding the bar 1 stationary and gradually elevating the base plate 26 from the retracted position thereof below the coating position thereof to the coating position thereof, no streaks were formed on a coating layer and a coating layer having a uniform thickness could be formed.

It is reasonable to conclude that this because in the case where a coating operation is started by rotating the bar 1 in a direction opposite to the transportation direction of the flexible support 6 and gradually elevating the base plate 26 from the retracted position thereof below the coating position thereof to the coating position thereof, a part of the coating solution transferred onto the surface of the flexible support 6 is held between the surface of the bar 1 and the surface of the flexible support 6 for some reason, so that streaks are formed on a coating layer, but to the contrary, in the case where a coating operation is started by holding the bar 1 stationary and gradually elevating the base plate 26 from the retracted position thereof below the coating position thereof to the coating position thereof, the coating solution transferred onto the surface of the flexible support 6 is scraped off by the clearance between the surface of the bar 1 and the surface of the flexible support 6 and excessive coating solution is prevented from being transferred onto the surface of the flexible support 6.

When the base plate 26 has reached the coating position thereof in this manner, the base plate driving mechanism is stopped and the base plate 26 is held at the coating position thereof.

When the base plate 26 is held at the coating position thereof, the bar driving mechanism 25 is driven, whereby as shown in FIG. 1, the bar 1 is rotated clockwise and the coating operation is started.

The pair of rubber rollers 21, 21 of each of the bar pressing devices 20, 20 is rotated in accordance with the rotation of the bar 1.

The flexible support 6 is transported by the transporting means (not shown) and since the flexible support 6 is strongly pressed onto the surface of the bar 1 by the upstream guide roller 7a and the downstream guide roller 7b, even if the flexible support 6 has local deformation such as local sagging, it is possible to coat the lower surface of the flexible support 6 with a coating solution and form a coating layer on the lower surface of the flexible support 6 in a desired manner.

In this embodiment, an amount of coating solution larger than that to be applied onto the lower surface of the flexible support 6, for example, 1.1 to 1.5 times the amount of the coating solution to be applied onto the lower surface of the flexible support 6, is fed.

Here, since the coating solution is fed via the pocket 3, the pressure fluctuation of a pump can be absorbed.

The slit 4 is formed so as to have a width of about 0.1 mm to about 0.2 mm in order to decrease the flow rate distribution of the coating solution fed through the slit 4 in the width direction.

Since the top portion of the second support block 2b has a substantially triangular cross section, the coating solution fed through the slit 4 forms a liquid pool 5 in the space between the top portion of the second support block 2b, the bar 1 and the pair of side plates 15, 15 and the coating solution forming the liquid pool 5 is transferred onto the lower surface of the flexible support 6.

In this manner, since the coating solution fed through the slit 4 forms a liquid pool 5 in a space between the top portion of the second support block 2b, the bar 1 and the pair of side plates 15, 15 and the coating solution forming the liquid pool 5 is transferred onto the lower surface of the flexible support 6, even in the case where the slit 4 is not fabricated with high accuracy so as to have a predetermined width, a desired amount of coating solution can be transferred onto the lower surface of the flexible support 6.

In this embodiment, since an amount of coating solution larger than that to be applied onto the lower surface of the flexible support 6, for example, 1.1 to 1.5 times the amount of the coating solution to be applied onto the lower surface of the flexible support 6, is fed, a part of the coating solution goes over the top portion of the second support block 2b and flows along the surface of the second support block 2b on the side opposite to the liquid pool 5, thereby being collected in a coating solution collecting section (not shown).

The coating solution transferred onto the lower surface of the flexible support 6 is metered by the bar 1 rotating clockwise in FIG. 1.

In this embodiment, since the width of the liquid pool 5 of the coating solution is restricted by the side plates 15, 15, it is possible to leave a region coated with no coating solution at the opposite edge portions of the flexible support 6. Therefore, when the flexible support 6 formed with a coating layer is reeled off, it is possible to reliably prevent the coating layers formed at the opposite edge portions of the flexible support 6 from adhering to themselves and the flexible support 6 from being torn when the flexible support is unwound.

Since the bar 1 is rotated while it abuts against the upper surface of the first support block 2a, a coating solution adhered to the surface of the bar 1 rotating clockwise in FIG. 1 and a coating solution accompanying the surface of the bar 1 are to be scraped off by the first support block 2a under normal conditions. However, since the bar 1 is generally slender in such a manner that the diameter thereof is about 10 mm, for example, and it tends to be warped or bent, the bar 1 is rotated in such a manner that the central portion thereof is eccentric. As a result, there arises a risk of a part of the coating solution adhered to the surface of the bar 1 or the coating solution accompanying the surface of the bar 1 being carried by the bar 1 without being scraped off by the first support block 2a and being transferred onto the surface of the flexible support 6 at the downstream of the bar 1.

However, in this embodiment, since the first support block 2a below the bar 1 is formed with the drain passage 8, the coating solution adhered to the surface of the bar 1 or the coating solution accompanying the surface of the bar 1 without being scraped off by the first support block 2a flows into the drain passage 8 together with a coating solution accommodated in a spiral groove formed on the surface of the bar 1 and is collected through the lower end portion of the drain passage 8 inclined downwardly. Therefore, it is possible to effectively prevent coating solution accommodated in the spiral groove formed on the surface of the bar 1, coating solution adhered to the surface of the bar 1 or coating solution accompanying the surface of the bar 1 from being transferred onto the surface of the flexible support 6 at the downstream portion of the bar 1.

Further, in this embodiment, since the doctor blade 10 formed so as to have a width larger than that of the liquid pool 5 and adapted for scraping off the coating solution adhered to the surface of the bar 1 and the coating solution accompanying the surface of the bar 1 is mounted on the third support block 2c, coating solution which has not flowed into the drain passage 8 and not been collected among the coating solution adhered to the surface of the bar 1 and the coating solution accompanying the surface of the bar 1 is scraped off by the doctor blade 10 and flows into the drain passage 8 to be collected. Therefore, it is possible to reliably prevent coating solution adhered to the surface of the bar 1 or coating solution accompanying the surface of the bar 1 from being transferred onto the surface of the flexible support 6 at the downstream portion of the bar 1.

Furthermore, as described above, since the bar 1 is slender, it tends to be warped or bent and it is rotated in such a manner that the central portion thereof is eccentric. As a result, since the contact between the central portion of the bar 1 and the first supporting block 2a deteriorates, whereby the contact pressure between the flexible support 6 and the bar 1 decreases, the amount of coating solution scraped off by the bar 1 at the central portion of the bar 1 may become different from that at regions close to the opposite end portions of the bar 1 and there arises a risk of the thickness of a coating layer varying.

Therefore, in this embodiment, the adjusting screw 30 is provided at the central portion of the base plate 26 for pushing up the central portion of the lower surface of the first support block 2a made of brass so as to be softer than the stainless steel forming the bar 1 and fixed to the base plate 26 so that the central portion of the bar 1 is pressed by the adjusting screw 30 onto the flexible support 6 via the first support block 2a, thereby making the contact pressure between the flexible support 6 and the surface of the bar 1 uniform.

For example, an amount of pushing up of the first support block 2a is set to be about 1 mm.

The adjustment of the amount of pushing up of the first support block 2a may be performed prior to starting a coating operation or after a coating layer is formed and observed. Further, it is possible to tentatively adjust the amount of pushing up of the first support block 2a prior to starting a coating operation and fine adjust it after a coating layer is formed and observed.

Furthermore, in this embodiment, since the portions of the bar 1 outside of the pair of side plates 15, 15 are pressed by the two rubber rollers 21, 21 of each of the bar pressing devices 20, it is possible to prevent the bar 1 from being rotated in such a manner that the central portion thereof is eccentric.

The coating solution forming the liquid pool 5 is transferred onto the lower surface of the flexible support 6 in this manner and excessive coating solution is scraped off by the bar 1, whereby a coating layer is formed on the lower surface of the flexible support 6.

According to the above described embodiment, since a coating operation is started by first holding the downstream guide roller 7b at the coating position thereof and the bar 1 stationary and gradually elevating the base plate 26 from the retracted position thereof toward the coating position thereof, even if the amount of coating solution transferred onto the surface of the flexible support 6 as the base plate 26 is elevated, the coating solution is scraped off by the clearance between the surface of the bar 1 and the surface of the flexible support 6. Therefore, it is possible to effectively prevent excessive coating solution from being transferred onto the surface of the flexible support 6 prior to starting a coating operation.

Further, according to the above described embodiment, since the liquid pool 6 is formed by a coating solution in the space between the top portion of the second support block 2b, the bar 1 and the pair of side plates 15, 15 and the coating solution forming the liquid pool 5 is transferred onto the surface of the flexible support 6, it is possible to easily control the amount of coating solution transferred onto the surface of the flexible support 6 in comparison with the case where a coating solution is directly discharged from a slit onto the surface of the flexible support 6 to be transferred.

Furthermore, according to the above described embodiment, since the pair of side plates 15, 15 is disposed inside of opposite edge portions of the flexible support 6 for defining opposite end portions of the liquid pool 5 and the width of the liquid pool 5 is restricted by the pair of side plates 15, 15, it is possible to leave a region coated with no coating solution at the opposite edge portions of the flexible support 6. Therefore, when the flexible support 6 formed with a coating layer is reeled off, it is possible to reliably prevent the coating layers formed at the opposite edge portions of the flexible support 6 from adhering to themselves and the flexible support 6 from being torn when the flexible support is unwound.

Moreover, according to the above described embodiment, since the first support block 2a is formed with a drain passage 8, a coating solution accommodated in the spiral groove formed on the surface of the bar 1, coating solution adhered to the surface of the bar 1 and a coating solution accompanying the surface of the bar 1 can be caused to flow in the drain passage 8 and collected through the lower end portion of the drain passage 8 formed to be inclined downwardly. Therefore, it is possible to effectively prevent coating solution accommodated in the spiral groove formed on the surface of the bar 1, coating solution adhered to the surface of the bar 1 and coating solution accompanying the surface of the bar 1 from being transferred onto the surface of the flexible support 6 at the downstream portion of the bar 1.

Further, according to the above described embodiment, since the doctor blade 10 having a width larger than that of the liquid pool 5 is mounted on the third support block 2c for scraping coating solution adhered to the surface of the bar 1, coating solution which has not flowed into the drain passage 8 and not been collected among the coating solution adhered to the surface of the bar 1 and the coating solution accompanying the surface of the bar 1 is scraped off by the doctor blade 10 and flows into the drain passage 8 to be collected. Therefore, it is possible to reliably prevent coating solution adhered to the surface of the bar 1 or coating solution accompanying the surface of the bar 1 from being transferred onto the surface of the flexible support 6 at the downstream portion of the bar 1.

Furthermore, according to the above described embodiment, since the doctor blade 10 is fixed to the third support block 2c by inserting it into a space between the first support block 2a and the third support block 2c, and the blade pressing plate 11 until it comes into abutment with the positioning pin 13 penetrating the blade pressing plate 11 and fastening the screw 12 after the doctor blade 10 comes into abutment with the positioning pin 13, the doctor blade 10 can be fixed to the third support block 2c by a simple operation.

Moreover, according to the above described embodiment, the adjusting screw 30 is provided at the central portion of the base plate 26 for pushing up the central portion of the lower surface of the first support block 2a made of brass so as to be softer than the stainless steel forming the bar 1 and fixed to the base plate 26 so that the central portion of the bar 1 can be pressed by the adjusting screw 30 onto the flexible support 6 via the first support block 2a. Therefore, even in the case where there is a risk of the bar 1 being rotated in such a manner that the central portion thereof is eccentric and the contact pressure between the flexible support 6 and the bar 1 being lowered, the contact pressure between the flexible support 6 and the surface of the bar 1 can be made uniform. Therefore, a coating layer having a uniform thickness can be formed.

Further, according to the above described embodiment, since the bar pressing devices 20 each having the two driven rubber rollers 21, 21 are disposed at portions of the bar 1 outside of the pair of side plates 15, 15 and each of the portions of the bar 1 outside of the pair of side plates 15, 15 is pressed by the two rubber rollers 21, 21 of the bar pressing device 20, it is possible to prevent the bar 1 from rotating in such a manner that the central portion thereof is eccentric.

Furthermore, according to the above described embodiment, since the upper surface of the base plate 26 is formed with two positioning pins 27, 27 and the lower surface of the first support block 2a is formed with two positioning holes 28, 28, the support block 2 can be located at a predetermined position and fixed to the base plate 26 by positioning the support block 2 so that the two positioning pins 27, 27 of the base plate 26 are inserted into the two positioning holes 28, 28 of the first support block 2a.

The present invention has thus been shown and described with reference to the specific embodiment. However, it should be noted that the present invention is in no way limited to the details of the described arrangements but changes and modifications may be made without departing from the scope of the appended claims.

For example, in the above described embodiment, although the downstream guide roller 7b is constituted so as to be movable between the coating position thereof and the retracted position thereof above the coating position, it is not absolutely necessary to constitute the downstream guide roller 7b so as to be movable between the coating position thereof and the retracted position thereof above the coating position and the downstream guide roller 7b may be constituted so as to be held at the coating position thereof.

Further, in the above described embodiment, although the first supporting block 2a is made of brass, it is not absolutely necessary to make the first supporting block 2a of brass. It is preferable for the first supporting block 2a to be made of a material softer than that of the bar 1 in order to prevent the bar 1 from galling and it is preferable for the first supporting block 2a to be flexible enough to be deformed by the adjusting screw 30. However, the material for forming the first supporting block 2a is not particularly limited and the first supporting block 2a may be formed of copper instead of brass.

Furthermore, in the above described embodiment, although the bar 1 is made of a stainless steel, it is not absolutely necessary for the bar 1 to be made of a stainless steel and the bar 1 may be formed by chromium-plating a carbon steel or the bar 1 may be formed by winding a wire around the outer surface of a bar-like member.

Moreover, in the above described embodiment, although the pair of side plates 15, 15 is made of polytetrafluoroethylene, it is not absolutely necessary for the pair of side plates 15, 15 to be made of polytetrafluoroethylene and the side plates 15, 15 may be formed of another plastics, a metal or alloy softer than that of the bar 1 or the like.

Further, in the above described embodiment, although the doctor blade 10 is made of polyester resin, it is not absolutely necessary for the doctor blade 10 to be made of polyester resin and the doctor blade 10 may be formed of polyamide resin such as nylon, high-density polyethylene resin or the like.

Furthermore, in the above described embodiment, although the supporting block 2 is divided into the first supporting block 2a, second supporting block 2b and third supporting block 2c, it is not absolutely necessary for the supporting block 2 to be divided into the first supporting block 2a, a second supporting block 2b and a third supporting block 2c.

Moreover, in the above described embodiment, although the top portion of the second supporting block 2b is formed so as to have a substantially triangular cross section, it is not absolutely necessary for the top portion of the second supporting block 2b to be formed so as to have a substantially triangular cross section and the cross section of the top portion of the second supporting block 2b is not particularly limited insofar as the liquid pool 5 can be formed so as to store a sufficient amount of a coating solution therein.

Further, in the above described embodiment, although the doctor blade 10 is fixed to the third supporting block 2c by inserting it into a space between the first supporting block 2a and the third supporting block 2c, and the blade pressing plate 11 until it comes into abutment with a positioning pin 13 penetrating the blade pressing plate 11 and fastening the screw 12 after the doctor blade 10 comes into abutment with the positioning pin 13, the method for fixing the doctor blade 10 is not particularly limited.

Furthermore, in the above described embodiment, although the upper surface of the base plate 26 is formed with two positioning pins 27, 27 and the bottom surface of the first supporting block 2a is formed with two positioning holes 28, 28, it is not absolutely necessary for the upper surface of the base plate 26 to be formed with two positioning pins 27, 27 and for the bottom surface of the first supporting block 2a to be formed with two positioning holes 28, 28 and it is possible to form two concave portions on one of the upper surface of the base plate 26 and the bottom surface of the first supporting block 2a and form two convex portions on the other of the upper surface of the base plate 26 and the bottom surface of the first supporting block 2a so as to correspond to the concave portions.

Moreover, in the above described embodiment, although the upper surface of the base plate 26 is formed with two positioning pins 27, 27 and the lower surface of the first supporting block 2a is formed with two positioning holes 28, 28, it is not absolutely necessary for the upper surface of the base plate 26 to be formed with two positioning pins 27, 27 and for the lower surface of the first supporting block 2a to be formed with two positioning holes 28, 28 and it is possible to form three or more positioning pins on the upper surface of the base plate 26 and form three or more holes on the lower surface of the first supporting block 2a.

Further, in the above described embodiment, although the bar pressing devices 20 each having the two driven rubber rollers 21, 21 are disposed at portions of the bar 1 outside of the pair of side plates 15, 15 and each of the portions of the bar 1 outside of the pair of side plates 15, 15 is pressed by the two rubber rollers 21, 21 of the bar pressing device 20, it is not absolutely necessary for each of the bar pressing devices 20 to have the two driven rubber rollers 21, 21 and it is possible to provide a pair of rubber rollers rotated by a drive mechanism in each of the bar pressing devices 20 and rotate the pair of rubber rollers at the same peripheral velocity as that of the bar 1.

Furthermore, in the above described embodiment, although the bar pressing devices 20 each having the two driven rubber rollers 21, 21 are disposed at portions of the bar 1 outside of the pair of side plates 15, 15 and each of the portions of the bar 1 outside of the pair of side plates 15, 15 is pressed by the two rubber rollers 21, 21 of the bar pressing device 20, it is sufficient for each of the bar pressing devices 20 to include driven rollers whose surfaces are formed of a high frictional material and it is not absolutely necessary for each of the bar pressing devices 20 to include the driven rubber rollers.

According to the present invention, it is possible to provide a bar coating method for using a bar coating apparatus which can be made at low cost to apply a coating solution onto the surface of a flexible support so as to form a coating layer having a desired thickness thereon.

1. A bar coating method comprising steps of feeding a coating solution to a space defined by a rotatable bar, a supporting block adapted for supporting the bar, formed with a slit through which the coating solution is fed at an upstream portion of the bar with respect to a transportation direction of a flexible support to be coated with a coating solution and detachably mounted on a base plate vertically movable and held at a coating position thereof, and a pair of side plates disposed on the opposite sides of the supporting block with respect to a widthwise direction of the flexible support through the slit formed in the supporting block, thereby forming a liquid pool, transferring the coating solution forming the liquid pool onto a surface of the flexible support while guiding the flexible support by an upstream guide roller disposed upstream of the bar with respect to the transportation direction of the flexible support and a downstream guide roller disposed downstream of the bar, metering an amount of the coating solution transferred onto the surface of the flexible support, and forming a coating layer on the surface of the flexible support, the bar coating method further comprising steps of gradually elevating the base plate from a retracted position thereof below the coating position thereof to the coating position thereof when starting a coating operation, while the bar is held stationary.

2. A bar coating method in accordance with claim 1, wherein the downstream guide roller is constituted so as to be movable between a coating position thereof and a retracted position thereof above the coating position and when a coating operation is started, the downstream guide roller is lowered from the retracted position thereof to the coating position thereof to be held at the coating position thereof.

3. A bar coating method in accordance with claim 1, wherein the pair of side plates are disposed inside of opposite edge portions of the flexible support to be coated with the coating solution.

4. A bar coating method in accordance with claim 2, wherein the pair of side plates are disposed inside of opposite edge portions of the flexible support to be coated with the coating solution.

5. A bar coating method in accordance with claim 1, wherein a top portion of the support block has a substantially triangular shaped cross section at an upstream portion of the bar.

6. A bar coating method in accordance with claim 2, wherein a top portion of the support block has a substantially triangular shaped cross section at an upstream portion of the bar.

7. A bar coating method in accordance with claim 3, wherein a top portion of the support block has a substantially triangular shaped cross section at an upstream portion of the bar.

8. A bar coating method in accordance with claim 4, wherein a top portion of the support block has a substantially triangular shaped cross section at an upstream portion of the bar.

9. A bar coating method in accordance with claim 5, wherein the support block includes a first support block for supporting the bar and a second support block whose top portion has a substantially triangular shaped cross section, the slit is formed between the first support block and the second support block, and the bar, the first support block, the second support block and the pair of side plates are disposed so that a coating solution fed through the slit formed in the support block forms the liquid pool in a space defined by the bar, the top portion of the second support block and the pair of side plates.

10. A bar coating method in accordance with claim 6, wherein the support block includes a first support block for supporting the bar and a second support block whose top portion has a substantially triangular shaped cross section, the slit is formed between the first support block and the second support block, and the bar, the first support block, the second support block and the pair of side plates are disposed so that a coating solution fed through the slit formed in the support block forms the liquid pool in a space defined by the bar, the top portion of the second support block and the pair of side plates.

11. A bar coating method in accordance with claim 7, wherein the support block includes a first support block for supporting the bar and a second support block whose top portion has a substantially triangular shaped cross section, the slit is formed between the first support block and the second support block, and the bar, the first support block, the second support block and the pair of side plates are disposed so that a coating solution fed through the slit formed in the support block forms the liquid pool in a space defined by the bar, the top portion of the second support block and the pair of side plates.

12. A bar coating method in accordance with claim 8, wherein the support block includes a first support block for supporting the bar and a second support block whose top portion has a substantially triangular shaped cross section, the slit is formed between the first support block and the second support block, and the bar, the first support block, the second support block and the pair of side plates are disposed so that a coating solution fed through the slit formed in the support block forms the liquid pool in a space defined by the bar, the top portion of the second support block and the pair of side plates.

13. A bar coating method in accordance with claim 9, wherein the first support block is made of a metal softer than that of the bar.

14. A bar coating method in accordance with claim 10, wherein the first support block is made of a metal softer than that of the bar.

15. A bar coating method in accordance with claim 11, wherein the first support block is made of a metal softer than that of the bar.

16. A bar coating method in accordance with claim 12, wherein the first support block is made of a metal softer than that of the bar.
